(19) United States
(12) Patent Application Publication
(10) Pub. No.: US 2025/0245568 A1
(43) Pub. Date: Jul. 31, 2025

(54) ROBOTIC PROCESS AUTOMATION UTILIZING MACHINE LEARNING TO SUGGEST ACTIONS FOR AUTOMATING PROCESSES

(71) Applicant: Automation Anywhere, Inc., San Jose, CA (US)

(72) Inventors: Harshil Lodhiya, Vadodara (IN); Virinchipuram Anand, Danville, CA (US)

(73) Assignee: Automation Anywhere, Inc., San Jose, CA (US)

(21) Appl. No.: 18/934,549

(22) Filed: Nov. 1, 2024

Related U.S. Application Data
(60) Provisional application No. 63/627,061, filed on Jan. 31, 2024.

(51) Int. Cl. G06N 20/00

(52) U.S. Cl. CPC G06N 20/00

(57) ABSTRACT

A system, method or computer readable medium for generating next suggested actions using generative Artificial Intelligence (AI). The system, method or computer readable medium can leverage the power of artificial intelligence algorithms to generate personalized, context-aware suggestions for user actions based on input data. By employing generative AI models, the system, method or computer readable medium can effectively anticipate user needs and provide intelligent recommendations to enhance user experiences across various domains.

### CROSS-REFERENCE TO RELATED APPLICATION

This application claims priority to U.S. Provisional Patent Application No. 63/627,061, filed Jan. 31, 2024, and entitled “METHOD AND SYSTEM FOR SUGGESTING ACTIONS FOR AUTOMATING PROCESSES,” which is hereby incorporated by reference herein.

### BACKGROUND OF THE INVENTION

Process automation systems enable automation of repetitive and manually intensive computer-based tasks. In an automation system, computer software, automation programs can be created to perform tasks that would otherwise be performed by humans. Some automation programs have the capability of mimicking the actions of a person in order to perform various computer-based tasks. For instance, an automation system can interact with one or more software applications through user interfaces, as a person would do. Such automation systems typically do not need to be integrated with existing software applications at a programming level, thereby eliminating the difficulties inherent to integration. Advantageously, automation systems permit automation of application-level repetitive tasks via automation programs that are coded to repeatedly and accurately perform the repetitive tasks.

Automation programs can be created by individuals of various levels of software development experience. Low code software development systems tend to allow those with lesser levels of software development experience create automation programs. However, creating automation programs may still require time, effort, and at times, at least a moderate level of development experience. To assist with accelerating the development of automation programs and for automation of processes, such as enterprise-level business processes, automation systems can seek to produce automation programs based on user requests so that the time and effort user's need to spend is substantially reduced. Therefore, there is a need for improved systems and method to produce automation programs for use by process automation systems.

### SUMMARY

A system and method for generating next suggested actions using generative Artificial Intelligence (AI) is disclosed. The system can leverage the power of artificial intelligence algorithms to generate personalized, context-aware suggestions for user actions based on input data. The suggested actions can be determined (e.g., predicted) based on previous selection of actions using generative AI. By employing generative AI models, the system can effectively anticipate user needs and provide intelligent recommendations to enhance user experiences across various domains.

The invention can be implemented in numerous ways, including as a method, system, device, or apparatus (including computer readable medium). Several embodiments of the invention are discussed below.

As a computer-implemented method for generating a dataset for training a machine learning model suitable for suggesting actions for automating processes, one embodiment can, for example, include at least: accessing a repository of an automation system which contains a plurality of files; identifying, by an automation file identification module, one of the plurality of files to be an automation file; filtering for automation process metadata within the files; removing automation process metadata corresponding to one or more automation steps that appear more than one time in an automation file; and generating a string format version of the identified automation file, wherein the string format version includes the identified automation process metadata.

As a computer readable medium including at least computer program code tangibly stored thereon for generating a dataset for training a machine learning model suitable for suggesting actions for creating automation files for user in an automation system that automates processes, one embodiment can, for example, include at least: computer program code for accessing a repository of an automation system which contains a plurality of files; computer program code for identifying, by an automation file identification module, one of the plurality of files to be an automation file; computer program code for filtering for automation process metadata within the files; computer program code for removing automation process metadata corresponding to one or more automation steps that appear more than one time in an automation file; and computer program code for generating a string format version of the identified automation file, wherein the string format version includes the identified automation process metadata.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like elements, and in which:

FIG. 1 is a block diagram of an automation environment according to one implementation.

FIG. 2 is a diagram of a process flow for producing automaton programs according to one implementation.

FIG. 3 is a diagram of a process flow for producing automaton programs according to an alternative implementation.

FIG. 4 illustrates a portion of a spreadsheet version of domain knowledge to be provided to the command package model, according to one implementation.

FIGS. 5A and 5B illustrate an example of an automation file that contains an automation program.

FIG. 6 illustrates a flow diagram of a process for training a machine learning model for the purpose of producing automation program code or portions thereof, according to one implementation.

FIGS. 7A and 7B illustrate system architectures for deployment of an automation platform utilizing automation ML models, according to certain implementations.

FIG. 8 is a block diagram of a robotic process automation system according to one embodiment.

FIG. 9 is a block diagram of a generalized runtime environment for bots in accordance with another embodiment of the robotic process automation system illustrated in FIG. 8.

FIG. 10 is yet another embodiment of the robotic process automation system of FIG. 8 configured to provide platform independent sets of task processing instructions for bots.

FIG. 11 is a block diagram illustrating details of one embodiment of a bot compiler illustrated in FIG. 10.

FIG. 12 is a block diagram of an exemplary computing environment for an implementation of a robotic process automation system.

### DETAILED DESCRIPTION OF CERTAIN EMBODIMENTS

A system and method for generating next suggested actions using generative Artificial Intelligence (AI) is disclosed. The system can leverage the power of artificial intelligence algorithms to generate personalized, context-aware suggestions for user actions based on input data. The suggested actions can be determined (e.g., predicted) based on previous selection of actions using generative AI. By employing generative AI models, the system can effectively anticipate user needs and provide intelligent recommendations to enhance user experiences across various domains. Additionally, the system can further include techniques for fine-tuning and deploying generative AI models to facilitate generation of accurate and relevant next suggested actions.

In order to create a machine learning model, an automation artificial intelligence model, suitable for suggesting automation steps, can take a set of automation sequences and process them to form a dataset appropriate for training the machine learning model. The dataset will include information relating to the specific automation platform, which allows for the machine learning model to be trained for that specific automation platform. Datasets for training automation Machine Learning (ML) models are used for suggesting automation program commands, command packages, or steps may be processed to identify the program elements command and command package names so that the ML model can be trained with regard to such commands and command packages. In alternative implementations, the training dataset can also include attributes for such commands and command packages. Such attributes, e.g. conditions of “if” commands such as checking if files exists or if a service is running, can improve the output generated by the ML model since such attributes provide more details as to the purpose and function of such packages and commands.

By suggesting next actions using generative AI, the system can greatly enhance the overall user experience in creation of automation programs. Advantageously, users can be provided with personalized and context-aware suggestions that align with their preferences and goals. The resulting automation programs can also be referred to as software robots, robotic agents, software agents, or bots.

The generation of next suggested actions enables users to optimize their workflows and decision-making processes to yield increased productivity and efficiency. By leveraging generative AI models, the system can analyze user behavior, patterns, and contextual information to identify the most suitable actions for specific situations.

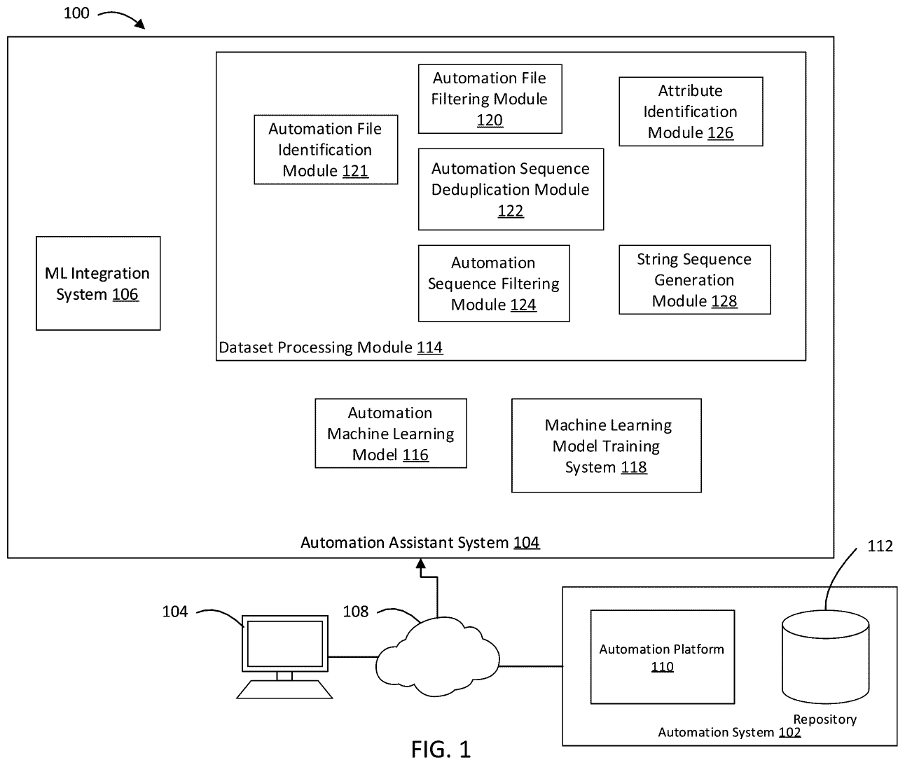

Embodiments of different aspects of the invention are discussed below with reference to FIGS. 1-12. However, those skilled in the art will readily appreciate that the detailed description given herein with respect to these figures is for explanatory purposes as the invention extends beyond these limited embodiments.

FIG. 1 illustrates a process automation system 100 that includes an automation assistant system 104, according to one implementation. Automation assistant system 104 includes an ML integration system 106, a dataset processing module 114, an automation machine learning model 116, and a machine learning model training system 118. The dataset processing module 114 includes an automation file filtering module 120, an automation sequence deduplication module 122, an automation sequence filtering module 124, an attribute identification module 126, and a string sequence generation module 128.

The process automation system 100 can also include automation platform 110 and repository 112. The repository 112 stores files used by the automation platform 110, such as automation files where each automation file may represent automation steps and sequences for automating tasks, which can be business or personal tasks. The automation assistant system 104 includes the automation machine learning model 116, which can be trained or fine-tuned to have the capability of producing outputs relevant to automation processes and programs by using automation files stored in repository 112 as training data. The automation files, such as from the repository 112, can form the corpus upon which the automation machine learning model 116 can be trained with. In some cases, the corpus includes hundreds of thousands to millions of automation files.

Techniques described herein can include techniques for identifying certain of the automation files and pre-existing automation programs, and then performing a sequence of data transformation steps that take the identified automation files and transform each of them into a single string of data that can form part of a set of training data for the automation assistant system 104. In some implementations, a single string can be a single string sequence, such as a Comma-Separated Values (CSV) line, that represents an automation file, such as a JSON file. The automation file can represent an automation program or sequence that automates a business process. For example, a business process might operate to pertain to a process for opening an email, opening an attachment, extracting text from the email or attachment, and then pasting the text into a spreadsheet.

An automation file can access the repository 112 of files for the automation system 102. The automation file filtering module 120 can filter for those of the files within repository 112 that are automation process related. These files, such as JSON files, are files that define automation processes and include various types of content needed for automation processes to execute, such as command packages, variables, triggers, nodes (workflow) and breakpoints (for debugging automation programs), automation program properties (such as versioning information), migration general, and work item templates. Such content can be in rich text format.

After accessing the repository 112, the automation identification module 121 can identify automation related files by identifying metadata within the files that may be helpful for training machine learning models with respect to automation processes.

Then, an automation file filtering module 120 can filter for files that may include information or metadata that are informative regarding the automation commands being executed and the sequence of such commands being executed. Also, for the automation assistant system 104 to more effectively produce automations with commands and corresponding attributes to allow execution of the automations, the filtering can also identify attributes that define the actions taken and the functionality provided by specific commands. For example, for an “IF” condition, automation file filtering module 120 filters for attributes such as if a file exists, if an application is running, if an object exists, or other such parameters.

Within each of the identified automation files, the filtering can seek to identify such informative metadata. Such files can include, but are not limited to: 1) JSON or XML data files that include automation related information; or 2) dependency parameters or files for file processing commands. A dependency parameter, for example, may specify the type of file or files that are needed for access by a command in order to execute an action. For example, a command may need a specific JSON, XML, Excel, or text file in order to execute.

Processing of datasets for training purposes aims to include metadata, such as programming elements, that defines actions of each automation process and defines events in workflow being automated. Metadata may be contained within nodes, a basic unit of a data structure, of each file type, for example within automation instructions. Examples of metadata include, but are not limited to: 1) command package names; 2) command names; or 3) attributes.

Command packages include one or more pre-programmed commands, which in turn are instructions capable of executing a step of an automation process. For example, a command package called “Loop” may have multiple commands (or actions) where each of the multiple commands may repeat a command based on different attributes (or parameters). The attributes for each of the Loop commands may be condition statements or iterator types. Program condition statements, such as “if-else”, “while”, etc. Some example conditions include Boolean conditions such as whether a file or object exists, if an application is running, or if an application window is open. The commands might iterate or loop, and might include Iteration elements and/or loop elements. Examples of loop elements cause execution of certain instructions multiple times, such as executing an action on each of multiple rows of a spreadsheet. Examples of attributes of objects, files, and programming elements, include: name, type, condition name, which mostly contain values like loop type, iterator, iterator TableRow, etc. Some attributes define what certain commands do, e.g. for “if” conditions, what specific component it checks on, like, if file exists, if application is running, if object exists, etc.

Elements within files that are may not be as helpful for machine learning models to understand the actions and purposes of actions in workflows include code comments and step commands. In some implementations, such metadata may be disregarded and not used to generate the string format version of the automation commands.

Command name and command package names can provide data in datasets such that automation ML models are able to distinguish between unique commands or iterators or conditions and to generate automation program code suggestions or suggestions for portions of such code. Datasets that also include command attributes can also provide models with increased accuracy for making such suggestions. For simple commands primarily, the command names and package names included in the training dataset can allow a model to distinguish actions taken by such commands. Attributes would describe how the action is being used. The following shows one format or syntax of how command names, package names and associated attributes can be shown in JSON files:

```
      {
        “commandName”: “messageBox”,
        “packageName”: “MessageBox”,
        “attributes”: [ ] // attributes for the command would go here
      }
      In the following example, metadata and IF commands are shown:
IF condition (or command)
        a. The following condition checks if file exists
[
  {
    “value”: {
      “type”: “CONDITIONAL”,
      “conditionalName”: “fileExists”,
      “packageName”: “File”
    },
    “name”: “condition”
  }
]
      b. The following condition checks if a JavaScript execution is successful
          [
            {
              “value”: {
                “type”: “CONDITIONAL”,
                “conditionalName”: “Success”,
                “packageName”: “JavaScript”
              },
              “name”: “condition”
            }
          ]
      c. The following condition checks for if child bot execution is successful.
          [
            {
              “value”: {
                “type”: “CONDITIONAL”,
                “conditionalName”: “Success”,
                “packageName”: “TaskBot”
              },
              “name”: “condition”
            }
          ]
```

Another automation command is a loop command. Metadata for loop commands includes its command name and command package name identifiers as well as attributes, e.g., whether the loop command is using an iterator or condition. Below is an exemplary loop command and its attributes.

```
{
  “commandName”: “loop.commands.start”,
  “packageName”: “Loop”,
  “attributes”: [
    {
      “name”: “loopType”,
      “value”: {
        “type”: “STRING”,
        “string”: “ITERATOR”
      }
    },
    {
      “name”: “iterator”,
      “value”: {
        “type”: “ITERATOR”,
        “iteratorName”: “loop.iterators.times”,
        “packageName”: “Loop”
      },
      “attributes”: [ ] // attributes for the iterator would go here
    }
  ],
  “children”: [
    // Child commands go here
  ]
}
```

The below are examples of attributes for a loop that runs for each file in a folder:

```
[
  {
    “name”: “loopType”,
    “value”: {
      “type”: “STRING”,
      “string”: “ITERATOR”
    }
  },
  {
    “name”: “iterator”.
    “value”: {
      “type”: “ITERATOR”,
      “iteratorName”: “loop.iterators.files”,
      “packageName”: “File”
    }
  }
]
```

The following are attributes for a loop that executes for each row in an Excel spreadsheet:

```
[
  {
    “name”: “loopType”,
    “value”: {
      “type”: “STRING”,
      “string”: “ITERATOR”
    }
  },
  {
    “name”: “iterator”.
    “value”: {
      “type”: “ITERATOR”,
      “iteratorName”: “loop.iterators.office365Excel”,
      “packageName”: “Office 365 Excel”
    }
  }
]
```

The following are attributes for a loop that executes for each row in a data table:

```
[
  {
    “name”: “loopType”,
      “value”: {
      “type”: “STRING”,
        “string”: “ITERATOR”
    }
  },
  {
    “name”: “iterator”,
    “value”: {
      “type”: “ITERATOR”,
      “iteratorName”: “iteratorTableRow”,
      “packageName”: “DataTable”
    }
  }
]
```

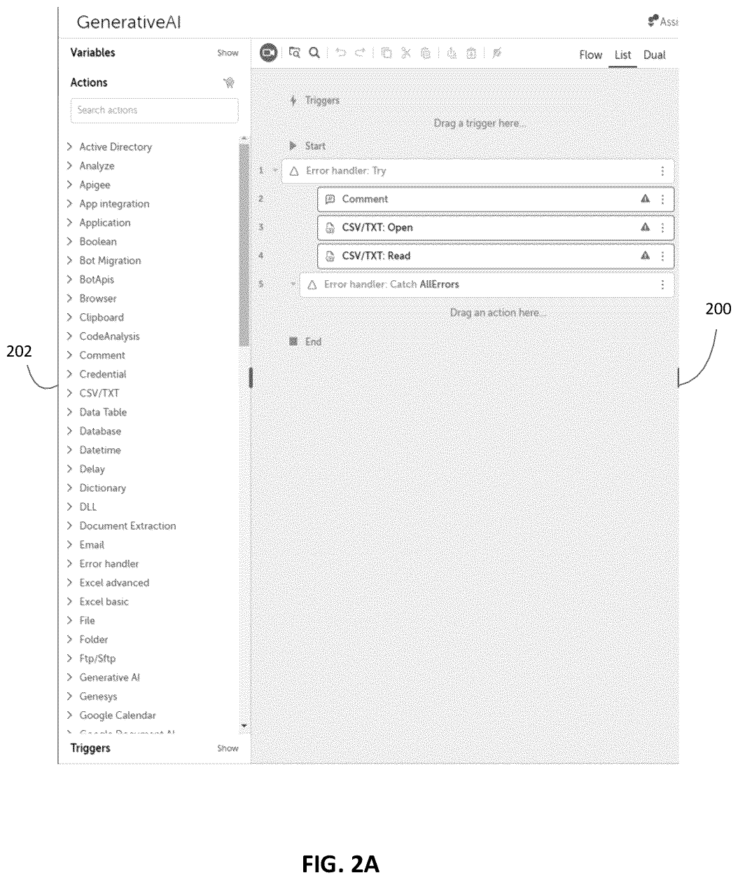

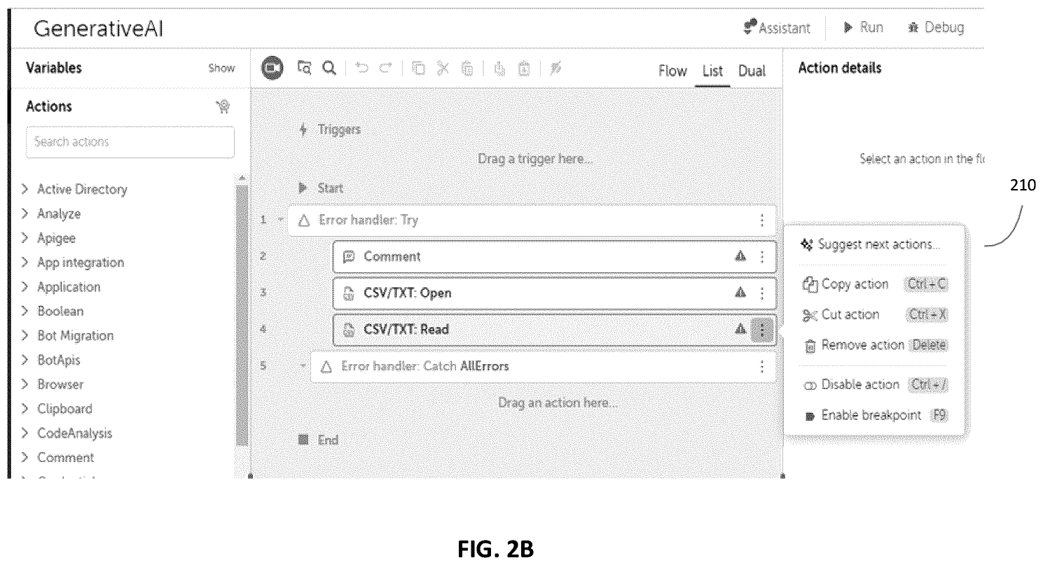

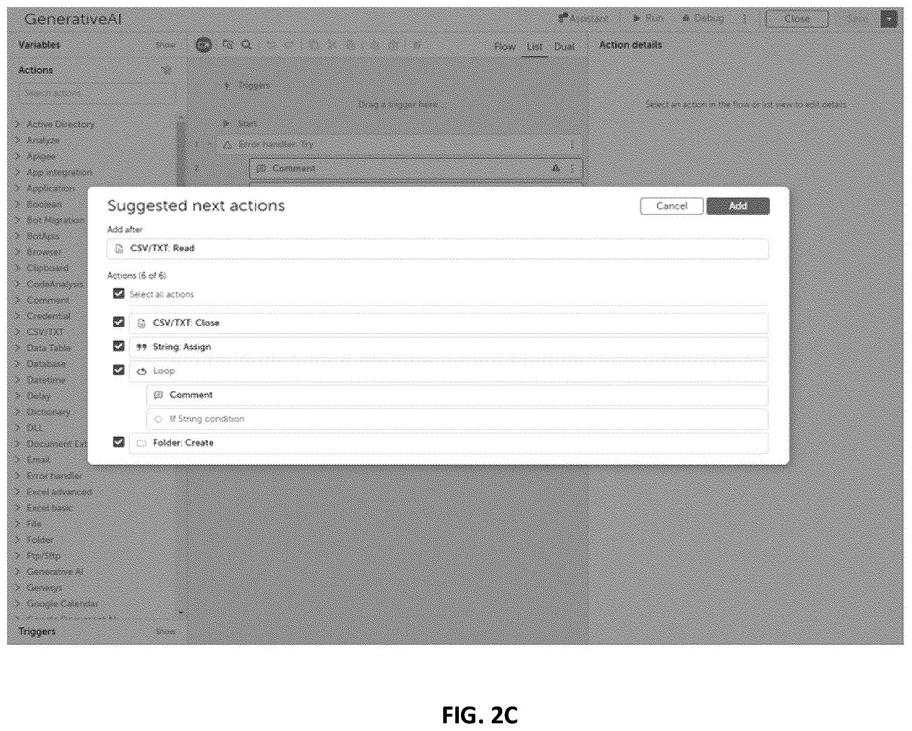

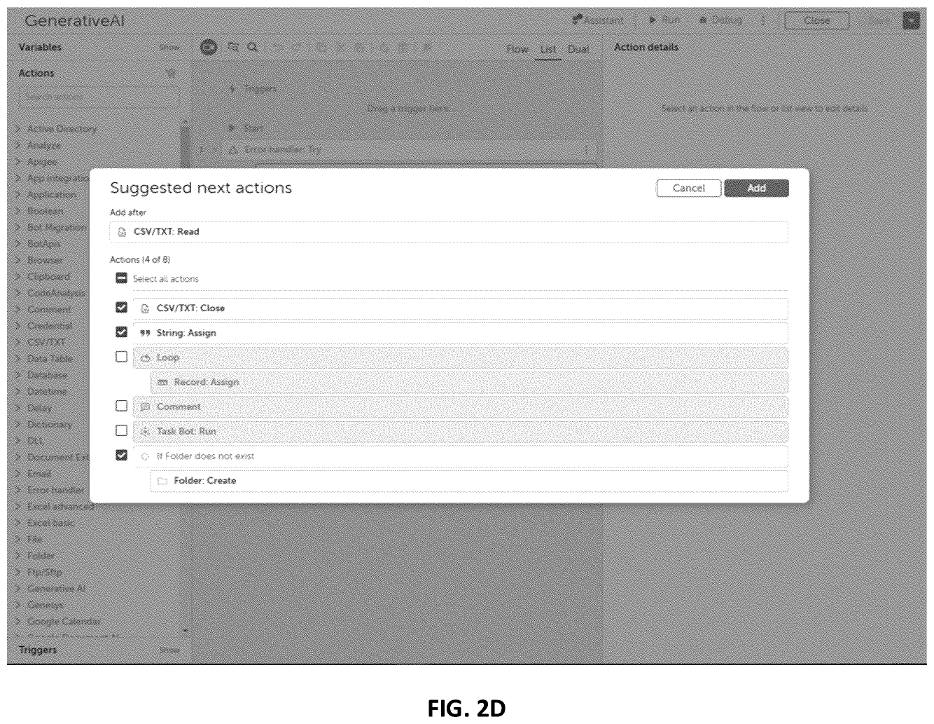

FIGS. 2A-2D illustrate screenshots of a user interface for a process automation system as a user creates an automation program or process and utilizes systems, and methods described herein that provide the user with suggestions and automation programs and processes, or portions thereof, that the user can incorporate into the automation program or process that the user is creating.

FIG. 2A illustrates a user interface of an automation process editor 200 that a user interacts with in order to design an automation process for use with a process automation system. During an automation design stage, a user works with the automation process editor to design a desired use case workflow or automation process. As can be seen in FIG. 2A, the automation process editor 200 includes a list or menu of many, sometimes hundreds, of commands or actions 202 that users can use to define and create workflows and automation processes. Within the automation process editor 200, a user is building an automation process to open a CSV/text file and then to read from the CSV/text file. To proceed further and add more automation process steps, the user may need to review all the command options that are available in list 202 available. In some cases, a user may need to refer to documentation in order to understand the functionality of each of the commands in order to knowledgably select appropriate commands to build an automation for a business process.

As illustrated in FIG. 2B, to overcome conventional difficulties and speed up the automation development process, a user can start with basic commands and ask for suggestions using the ellipse icon on one of the command or action rows which allow the user to generate and insert a next command or set of commands. A user may click on “Suggest next actions” 210 in order to request the systems described herein to provide suggested commands and command packages to assist the user to develop an automation process.

As illustrated in FIG. 2C, after a user clicks on “Suggest next actions” 210 illustrated in FIG. 2B, the system herein can generate suitable actions that can follow the CSV/text read command to assist the user in developing the automation process. The system herein suggests to the user to: 1) close the file once read from, 2) use a string operation to assign a read value to a variable, 3) if required, to loop through data and compare generated strings to determine if they are valid or not, and 4) to create a folder (that does not exist) so that data can be stored in it at a later point in the process. The system here may suggest automation programs or portions thereof that include the names of commands, command packages, and attributes. The suggested automations may be ready for execution by an automation platform or they may require some further revision by developers.

FIG. 2D illustrates a scenario where a user deselects three of the suggested automation commands such that the remaining commands with checked boxes will be added into the automation process. Then the user can click on the Add button to add the selected commands to the automation process. As a result, automation assistant system 104 has helped the user add automation program commands to more fully automate a process that the user is developing.

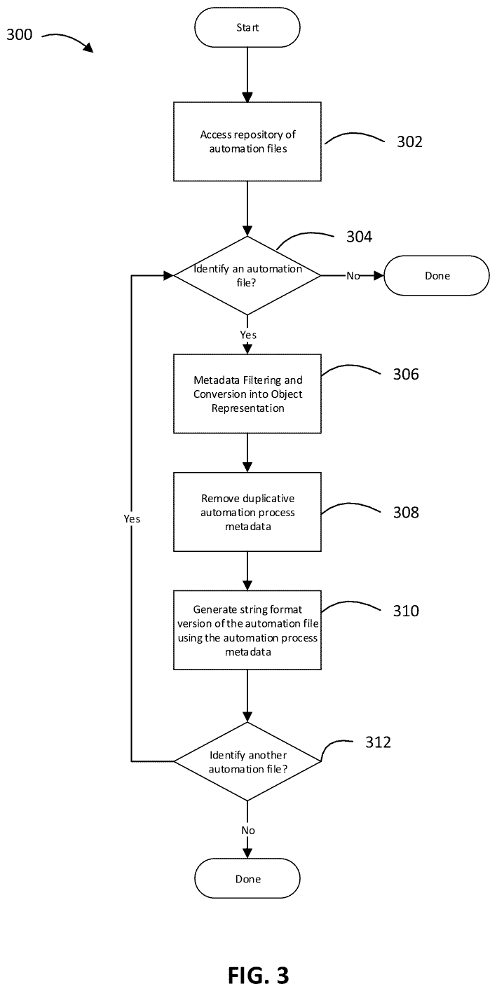

FIG. 3 is a flow diagram of a process 300 representing a process for preparing a dataset suitable for training an automation machine learning model for the purpose of assisting with the development of automation programs according to one implementation.

In step 304, the automation file identification module 121 reviews the repository 112 of the automation system 102 in order to identify automation files. The automation file identification module 121 performs a conditional check on all or a subset of the files within repository 112 to determine if files are automation related files. In some implementations, the automation file identification module 121 reviews and identifies automation files if a reviewed file has an automation structure and contains a section or field for the names of commands and command packages. Depending on certain file structures of particular automation systems, such fields may be contained within a higher-level field or section where such a field may be called a node field. Other fields that may be identified and associated with a file as an automation field may be attributes, variables, and children fields. In some implementations, automation files may be JSON or XML files. On the other hand, automation file identification module 121 may identify certain files as not being automation files, such as dependency files. Dependency files, are files that are needed for an automation to properly execute but which are not automation files themselves. Such dependency files may have file extensions such as .png, .pdf, .xls, or any other extensions for files that may be need to be used as part of an automation process, but for which are not automations in themselves. Other non-automation files may be JSON or XML files that do not contain automation file structures and do not contain automation related fields such as nodes, command package names, command names, attributes, variables, or children.

In step 306, metadata filtering reviews the automation files for automation program metadata that is indicative of the purpose and function of the actions within the automation program. The metadata filtering can be performed by the automation file filtering module 120 shown in FIG. 1. In some implementations, metadata filtering can be implemented via scripts or software programs, e.g., software programs written in the python language. The filtering algorithms of such software programs can be designed to look for certain command packages, commands, and in some instances, the attributes of the commands. In addition to filtering operations within step 306, the metadata that is identified through the metadata filtering process is then converted into object representational format. In some implementations, this conversion process can be implemented by using a software program, such as a python program, that has been programmed to do so.

In step 308, the automation sequence deduplication module 122 removes duplicates of metadata relating to similar/same actions since inclusion of duplicates (more than 2 instances of the same commands) in the training data tends to lower the rate of successful training of the machine learning models, in that they have a lower likelihood of generating automations that successfully automate workflows.

In automation systems, when automatic web application or processing repetitive actions, the use of same commands or actions can be performed multiple times, e.g. an automation recorder capturing action can be used to automate all textboxes in a form filling. Remove if action repeats more than once in next three actions. That means at any point of time, no three actions will have duplicate sequence block.

In step 310, sequence generation is performed where the dataset generation process is applied to the automation files that have been identified in a repository for automation program files. The process generates a string format of the metadata and attributes to result in a string representation of automation instructions for each automation instruction found in the files. A decision in step 312 causes the process 300 to repeat so that each of the identified automation files can be processed.

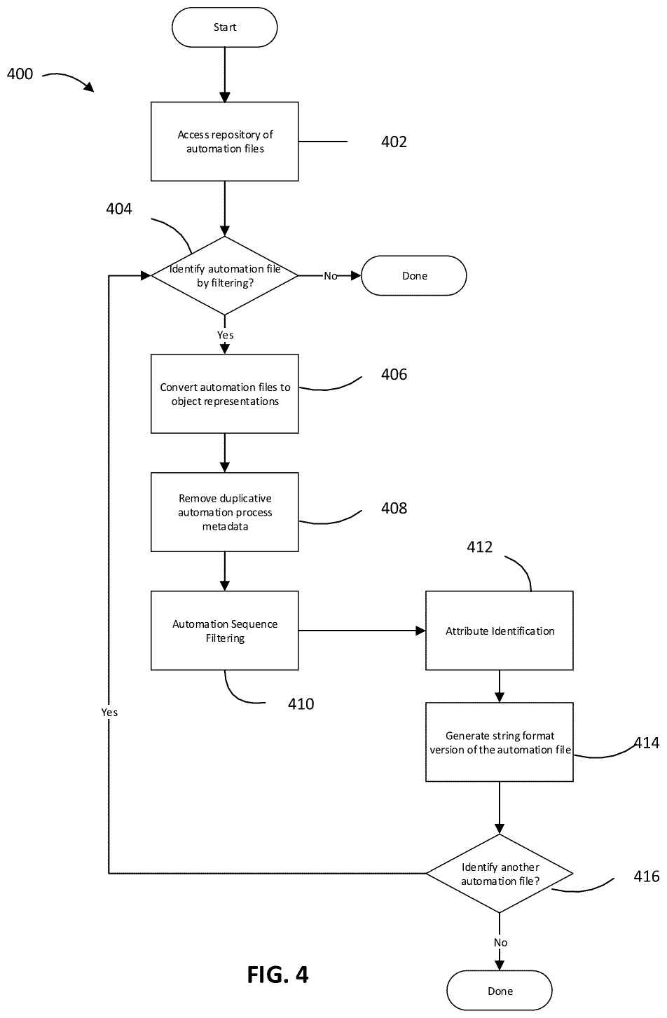

FIG. 4 is a flow diagram that illustrates a process 400 for processing files of an automation program to produce a text version of the file that is suitable for use in a dataset for training or validating a machine learning model, according to one implementation. In step 402, a repository of automation files is accessed. Then, in decision step 404, the files in the repository are reviewed in order to identify files that are files, such as JSON files, that contain automation programs. In some cases, such review is performed by filtering for automation program metadata that matches such metadata contained within a reference list of automation program metadata associated with a software automation system. Such automation program metadata can be, for example, one or more of names of commands, command packages, and related attributes.

Note that one of the nodes relating to calling a third-party software service using the command package “3rd party NLP service” will not be represented in the automation program object representation (to be shown below) since this command package is not in the reference list of automation program metadata. This can be the case where such 3rd party service is not a standard command package supported by the automation system. For the purposes of illustrating the review and filtering process of step 404, the representation of the automation program below will show this 3rd party command package being struck out as it will not appear in the automation program represented at the end of step 406.

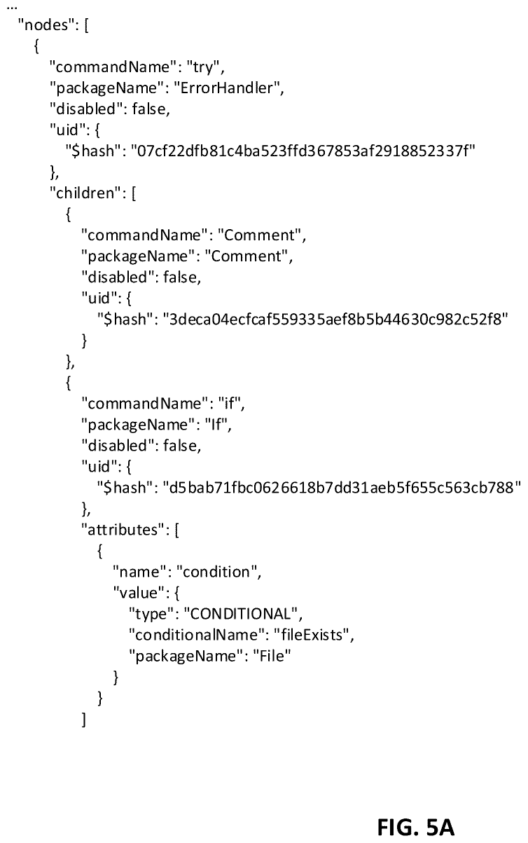

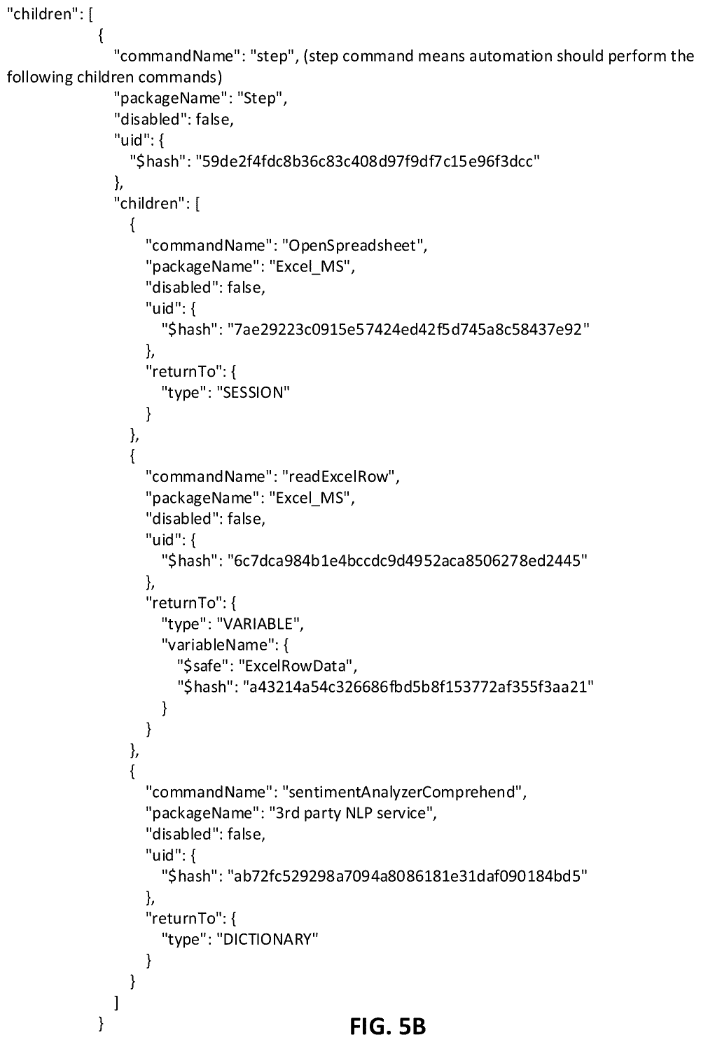

FIGS. 5A and 5B illustrate an example of an automation file that contains an automation program that is identified in step 404. In this example, the represented automation file has a JSON format and begins in FIG. 5A and extends into FIG. 5B. The automation file includes various nodes where each node corresponds to different packages and commands. This automation file includes a command named “try”, which is a command within a command package named “ErrorHandler”. As should be understood, this command directs the automation to try the subsequent sequence of commands in the event that a program execution error is encountered. According to the automation program shown, a comment command, which is part of a comment command package, and an “if” command, which is part of an “if” command package, are performed. Then, when the condition of the if command is met, multiple commands are performed, including “openSpreadsheet”, “readExcelRow”, and utilizing a third-party machine learning service for the purpose of analyzing the sentiment of certain text.

Then, in step 406, automation program files identified in step 404 can be converted into object representational format. In some implementations, this conversion process can be implemented by using a software program, such as a python program that has been programmed to do so. The object representation of the JSON file in FIGS. 5A and 5B can be seen below.

For the purpose of providing further information using this example, additional program nodes have been included below, which represent automation programming in additional to what is shown in the JSON file of FIGS. 5A and 5B. In the example below, the additional nodes relate to capture commands that are part of a recorder command package. The capture commands can perform the action of recording interactions with user interface elements such as clicks, reading information, and writing to fields within a software application.

Nodes
Command: try, Package: ErrorHandler
   Command: comment, Package: Comment
   Command: if, Package: If
      Command: step, Package: Step
      Command: openSpreadsheet, Package: Excel_MS.
      Command: readExcelRow, Package: Excel_MS
      Command: step, Package: Step
      Command: Capture, Package: Recorder
      Command: Capture, Package: Recorder
      Command: Capture, Package: Recorder
   Command: catch, Package: ErrorHandler
      Command: messageBox, Package: MessageBox

In step 408, the automation sequence deduplication module 122 reviews the output of step 406, the object representation of the automation file, and identifies any commands that appear more than once in the automation file. Such duplicative commands and their corresponding command packages are then removed such that a single instance of a command and the corresponding command package is left remaining in the representation of the automation program.

In instances where a command and its command package appear more than one time in the automation program, but are separated by other automation commands and packages, then the commands will be persisted or maintained in the code representation.

Removing duplicative instances of commands and command packages results in a training dataset that allows the automation machine learning model to produce automation program suggestions that more accurately satisfy users' requests for automation program development assistance. Such deduplication decreases the bias of model training. Also, in most automation programs, automatically or programmatically simulating a user's click and keystrokes are performed multiple times since a user may have clicked or used certain keystrokes multiple times when performing certain tasks. However, the automation assistant system 104 need not recommend including such command actions multiple times for inclusion in automation program. Training automation machine learning models with single, rather than multiple, instances of a user's action allows the automation learning model to suggest such a command one time, then an automation developer or the use can decide to replicate the single command depending on the user's discretion to duplicate such command actions.

In this example automation program, the capture command of the recorder command package appears three times in succession. As such, the automation sequence deduplication module 408 removes the second and third instances of this command and command package, such that the output of this step 408 in one implementation can be as follows:

Nodes
Command: try, Package: ErrorHandler
   Command: comment, Package: Comment
   Command: if, Package: If
      Command: step, Package: Step.
      Command: openSpreadsheet, Package: Excel_MS.
      Command: readExcelRow, Package: Excel_MS
      Command: step, Package: Step
      Command: Capture, Package: Recorder
   Command: catch, Package: ErrorHandler
      Command: messageBox, Package: MessageBox

In step 410, the automation sequence filtering module 124 reviews the output of step 408 in order to remove commands, command packages, and other automation program metadata from the object representation of the automation file that do not represent actions taken by the program that are informative to the automation ML model for the purposes of producing automation program suggestions. In other instances, the automation sequence filtering module 124 can remove commands that do not facilitate improved automation ML model training.

For example, some metadata, such as the step command and a comment command are useful commands for the purpose of automation program code structure and executing automation programs. However, such commands are not helpful metadata in terms of providing insight into the type of actions and functionality that the automation program provides. For instance, it is typically understood that step commands cause the execution of a line or a sequence of code or commands. In other words, step commands can be commands that facilitate the functioning of an automation program, but do not provide substantial insight into the types of actions being taken. On the other hand, comment commands typically include a software developer's description of the purpose of certain lines of program code. In some instances, such description could be helpful metadata to describe the functionality of automation programming; however, in some instances, such metadata are not helpful portions of training data for automation ML models.

In other instances, automation sequence filtering module 124 can review the output of step 410 to identify and remove automation program elements that may not be supported by a specific user's instance of the automation system. Such elements are removed so that the automation ML model is less likely to suggest any automation program functionality that is not supported by that user's automation system. For example, some automation files within the automation process repository may include commands or command packages that were custom designed by other users.

In this running example, after automation sequence filtering module 124 removes portions of the automation program as shown by the lines that are struck-through:

Nodes
Command: try, Package: ErrorHandler
   Command: if, Package: If
      Command: openSpreadsheet, Package: Excel_MS.
      Command: readExcelRow, Package: Excel_MS
      Command: Capture, Package: Recorder
   Command: catch, Package: ErrorHandler.
      Command: messageBox, Package: MessageBox

In one embodiment, sequence filtering can review automation string to identify and remove metadata relating to command packages and commands that do not appear in a master list of generally available packages supported by a corresponding automation system, such as the automation system 102. This is so training data will include metadata that will lead to generation of packages and commands that can be used by all users. In other words, in some instances, it is not desirable to train the model to generate automation program suggestions that only a subset of users can use. Sequence filtering can be executed by program code, such as such in the Python programming language. Such code's logic can follow the steps of checking for certain commands/packages names, then identify those for string generation, and looking for specific associated attributes.

In step 412, attribute identification module 126 of FIG. 1 identifies attributes of the commands and command packages and populates them into the output of step 410. Certain commands have associated attributes that help define how such commands execute. For example, condition commands require attributes to determine what conditions should be checked for being true or false before executing. And loop commands require attributes that determine how many times certain instructions should be repeated. Additionally, the attributes of the “if” command include the attribute type, the condition name, and the command package name, which in this case are “CONDITIONAL”, “fileExists”, and “File”, respectively. For this “if” command, the ensuing commands are performed on the condition that files exist. The object representation of the automation program is shown below with the attributes populated:

Nodes
Command: try, Package: ErrorHandler
   Command: if, Package: If, Type: condition, ConditionName: fileExists, PackageName: file
      Command: openSpreadsheet, Package: Excel_MS.
      Command: readExcelRow, Package: Excel_MS
      Command: Capture, Package: Recorder, Name: UIObject, Technology Type: HTML, BrowserName: Chrome
   Command: catch, Package: ErrorHandler.
      Command: messageBox, Package: MessageBox

As shown, attributes have also been added for the capture command. These attributes represent the specific parameters for performing the capture command where Capture commands interact with UIElement (UIObject) which is in CHROME browser of type HTML.

In some implementations, the repository (e.g., repository 112) maintains a specification, list, or matrix that maps commands to respectively corresponding attributes. For example, for a command for recording user activities for the purpose of understanding and documenting such activities, such specifications indicate which certain attributes need to be identified, such as control type, technology type and browser type.

In step 414, the string sequence generation module 128 of FIG. 1 converts the output of step 412 such that the object representation of the automation program is represented in a text string format. Branch terminators can also be added into the string in order to highlight the end of conditions, loops, if commands, and other commands.

In one embodiment, as part of the conversion process, each line of the automation program is rewritten into a single text line where a command, and its corresponding command package, and attributes, if any, are grouped together, and then each of the multiple groupings are included in the single text line. For example, the first line of the automation program, which includes the command and command package key and value pairs represented as, “Command: try, Package: ErrorHandler”, will be converted into a representation with the syntax of: (cmd:try|pkg:errorhandler), and the next line of, “Command: if, Package: If, Type: condition, ConditionName: fileExists, PackageName: file”, will be converted to: (cmd:if|pkg:if|name:condition|type:conditional|conditionalname:fileexists|pkgname:file). As can be seen the format or syntax to which each line is converted retains a key and value separated by a colon. In other embodiments, the use of parentheses and vertical bar separators can be replaced with other separators such as square brackets [ . . . ], curly brackets { . . . } or angle brackets < . . . >.

After the conversion process, at step 414, the sequence generation module 128 outputs the automation program reformatted as:

Nodes
(cmd:try|pkg:errorhandler)
   (cmd:if|pkg:if|name: condition|type: conditional|conditionalname: fileexists |pkgname: file)·
      (cmd:openspreadsheet|pkg:excel_ms).
      (cmd:readexcelrow|pkg:excel_ms)
      (cmd:capture|pkg:recorder|name: uiobject|techname: html|bwsrna me: chrome) (cmd:endif|pkg:if)
   (cmd:catch|pkg:errorhandler)
      (cmd:messagebox|pkg:messagebox) (cmd:catch.end|pkg:errorhandler) (cmd:try.end|pkg:errorhandler)

Note however that the sequence generation process also added two branch terminators to mark the end of each program node. The branch terminator of (cmd:endif|pkg:if) marks the end of the if command. The branch terminator of (cmd:catch.end|pkg:errorhandler) (cmd:try.end|pkg:errorhandler) marks the end of both the try and the catch commands of the ErrorHandler command package.

Then the syntax converted form of the automation program is converted into a single text string format, which may then be used as a piece of data within a dataset for training the automation ML model. For the example, the single text string format of the automation program is:
(cmd:try|pkg:errorhandler) (cmd:if|pkg:if|name: condition|type: conditional|co nditionalname: fileexists|pkgname: file) (cmd:openspreadsheet|pkg:excel_ms) (cmd:readexcelrow|pkg:excel_ms) (cmd:capture|pkg:recorder|name: uiobject|technam e: html|bwsrname: chrome) (cmd:endif|pkg:if) (cmd:catch|pkg:errorhandler) (cmd:messa gebox|pkg:messagebox) (cmd:catch.end|pkg:errorhandler) (cmd:try.end|pkg:errorhan dler)

As can be seen, the automation program metadata is structured to identify the command name, then the command package name, and then the attribute value or values, in an example structure such as: (cmd:name|pkg:name|attr: value). However, in alternative implementations, the order, format or names of the key value pairs could be rearranged.

In step 416, the process 400 step proceeds to check if a next automation file has been identified. If so, then the next automation file is processed and converted to a single text file format as described above. If no next file is identified, then the process 400 comes to completion. The resulting string represents the automation file, e.g., a JSON file, in a form that is simpler and more suitable for feeding into an automation machine learning model.

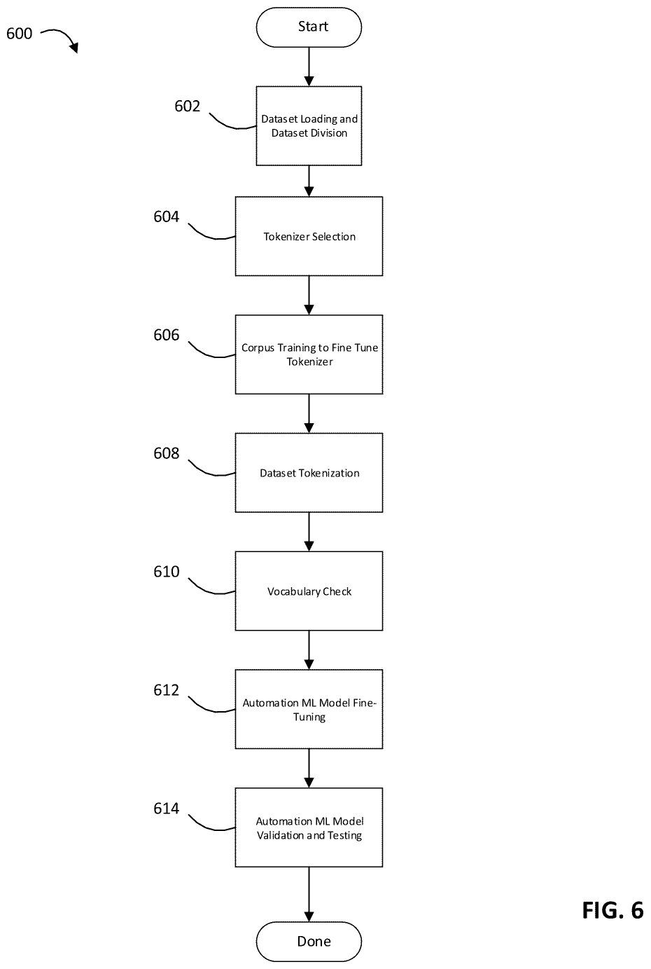

FIG. 6 illustrates a flow diagram of a process 600 for training a machine learning model for the purpose of producing automation program code or portions thereof, according to one implementation. The process 600 involves training a tokenizer and fine tuning a large language model on the dataset prepared as described above.

The process 600 starts by loading the dataset 602 produced according to the processes described above into the automation machine learning model or a machine learning integration system. The dataset can be in CSV format and can be divided into two parts where one part is used for training the automation machine learning model and another part can be used for validation testing. In some implementations, about 90% of the dataset can be used for model training and the remaining 10% can be used for validation. During training of the model, after each epoch, the model can be validated on validation portion of the dataset and a loss can be calculated.

The automation machine learning model can be a foundational or large language model that has been trained on a large dataset of training data. In some implementations, the machine learning model could be a GPT (Generative Pretrained Transformer) model such as GPT2 Version 2, which is available through OpenAI, L.L.C.

In step 604, a tokenizer is selected, which will be used to tokenize the dataset. For example, the GPT Version 2 pre-trained model tokenizer or GPT2TokenizerFast can be used. As should be understood, tokenization is the process of converting a sequence of text into smaller parts, known as tokens, where each token can be more easily be assigned a meaning that is useful to a machine learning model. The resulting set of tokens establishes a vocabulary for the dataset.

In some implementations, a developer may choose to train a tokenizer or the developer may be able to choose a pre-trained tokenizer.

In step 606, the selected tokenizer is fine-tuned using the dataset. Fine-tuning the tokenizer is a statistical process that identifies subwords for a given dataset corpus, which is the collection of data that serves as training material for artificial intelligence systems. Each tokenizer has a specific tokenization algorithm for identifying subwords. The fine-tuned tokenizer can be used on the dataset in order to prepare vocabulary in addition to the vocabulary set the tokenizer was provided with in order to better fine-tune the automation machine learning model. As described in this disclosure, the dataset prepared with the processing steps can be specific to certain software automation platforms and so the fine-tuning of the tokenizer and the machine learning models allow for better model outputs and results based on the specific format, structure and syntax of the automation programs for the platform. In other words, fine-tuning the tokenizer allows the automation machine learning model to better understand the automation platforms specific vocabulary.

As should be understood, creating new vocabulary from strings uses predefined script provided with machine learning or large language model frameworks in order to fine tune the tokenizers. Then developers can feed the generated datasets into a tokenizer using these pre-defined scripts to train the tokenizer. Then the output of dataset generation process will be unique to the specific automation platforms.

In step 608, the fine-tuned tokenizer is used to tokenize the dataset, for example, by dividing the dataset into smaller parts, or tokens. These tokens are then converted into numerical vector representation, which is suitable for use as inputs into the automation machine learning model. In one example, one of the automation programs in text string format, which is part of the tokenizer's training corpus, could be:
(cmd:assign|pkg:string) (cmd:messagebox|pkg:messagebox) (cmd:beforeafter|pkg:string)

Then the tokenized version, or the tokenizer corpus, of the text string becomes:

[‘(’, ‘cmd’, ‘:’, ‘ass’, ‘ign’, ‘|’, ‘pkg’, ‘:’, ‘string’, ‘)’, ‘Ġ(’, ‘cmd’, ‘:’, ‘message’,
‘box’, ‘|’, ‘pkg’, ‘:’, ‘message’, ‘box’, ‘)’, ‘Ġ(’, ‘cmd’, ‘:’, ‘before’, ‘after’, ‘|’, ‘pkg’, ‘:’, ‘string’,

Each of these smaller subsets of the words form the vocabulary, or the collection of words and suffixes, for training purposes.

A vector representation of the tokenized string or entry for fine-tuning of the automation ML model becomes:
entry: [7, 28758, 25, 562, 570, 91, 35339, 25, 8841, 8, 357, 28758, 25, 20500, 3524, 91, 35339, 25, 20500, 3524, 8, 357, 28758, 25, 19052, 8499, 91, 35339, 25, 8841, 8]

Within the tokenized string, each of the numbers represents each portion of the tokenized corpus. For example, each of the colons is represented by the number 25.

In step 610, process 600 reviews, validates, and divides the tokenized dataset, or vocabulary, into smaller batches. Validating that the tokenized dataset includes validating that the vocabulary exists within a dictionary corresponding to the automation platform. Also, at step 610, the dataset undergoes a data collation process. Data collation is a process of using both the tokenizer and the dataset to validate tokenized dataset in bulk.

In step 612, process 600 proceeds to fine-tuning of the automation ML model using the tokenized dataset produced in step 610. Fine-tuning the model involves adjusting at least one parameter of the automation ML model to so that it may generate output for the specific use cases for which the dataset is tailored for. For example, a pre-trained large or small language model may have up to or more than 124 million parameters, one or more of which may be fine-tuned. In some processes, supervised fine-tuning techniques may be used to fine-tune the automation ML model. Also, any one or more of the specific techniques such as early stopping, half-precision training, mixed-precision arithmetic training, gradient checkpointing, and perplexity techniques may be used.

In some implementations, early stopping techniques may involve using early stopping callbacks with a default ‘early_stopping_patience’ value of 3, which ensures that a minimum of three epochs run before training stops.

In some other implementations, half-precision training (FP16) or mixed-precision arithmetic training techniques, which forms of floating-point arithmetic that use numbers with varying widths in a single operation. Using these techniques allows for loading large size models in memory with smaller memory footprints while maintain desired levels of accuracy.

Gradient checkpointing techniques can be used to reduce memory usage footprints and enables the training on large datasets.

Perplexity is a statistical measure of how confidently a language model predicts a text sample. In other words, it quantifies how “surprised” the model is when it sees new data. The lower the perplexity, the better the model predicts the text. In some implementations, it may be desirable to achieve a training perplexity of 1.2 and a validation perplexity of 1.19.

At the end of training, the process 600 yields a fine-tuned model that is ready for integration and deployment within an automation platform so that users can request and receive automation program coding suggestions.

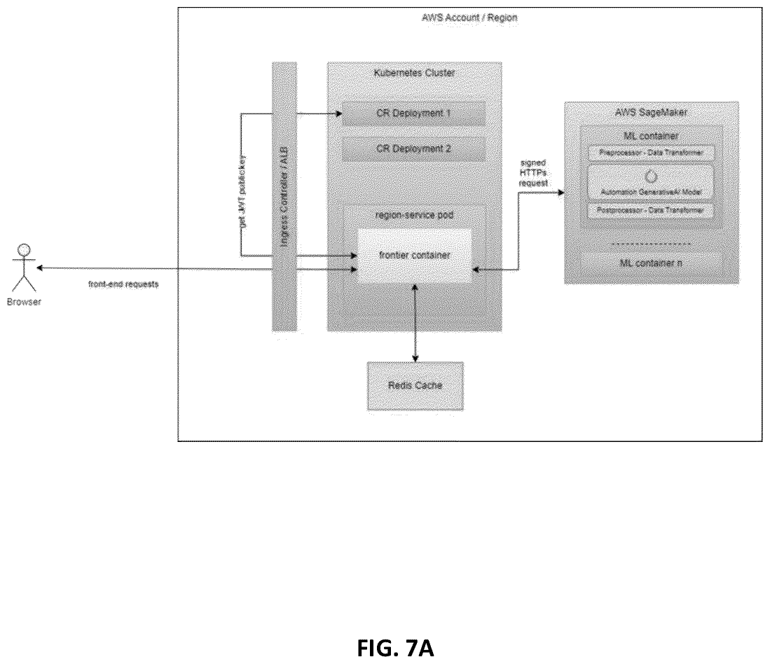

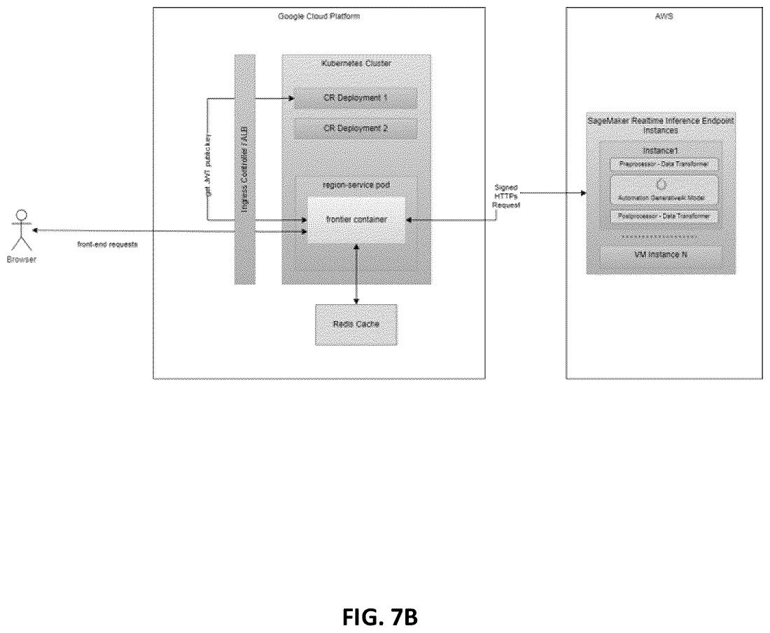

FIGS. 7A and 7B illustrate system architectures for deployment of an automation platform utilizing automation ML models, according to certain implementations. The architectures utilize sidecars, supporting processes or services that are deployed with the primary application, such as for those for reverse proxy services. Such sidecars can also provide authorization by validating a JWT (JSON Web Token) provided in the X-Authorization header with the public key of the deployment that issued it. The public key for a deployment is retrieved by determining the deployment from the Host (header of the request), and retrieving, and then caching in-memory (for approximately 300 seconds) the public key via unauthenticated HTTP call to the deployment. The sidecars can also provide global rate limiting using a data structure server, such as Redis, as a bucket store.

All incoming HTTP requests may be handled by the sidecar container and forwarded to the business logic container over local host as HTTP. The ingress of the control room, the automation platform's control node, may be configured to forward a path prefix to the region-service.

The sidecar is the only container for a region-service as it provides authorization and rate limiting as described above, and it also transforms the incoming request into a request for a machine learning training and deployment software service and signs the request using credentials provided via a Kubernetes service account. The ingress of the automation platform control node may be configured to forward a path prefix to the region-service. Inference workloads run as containers within the training and deployment real-time endpoint.

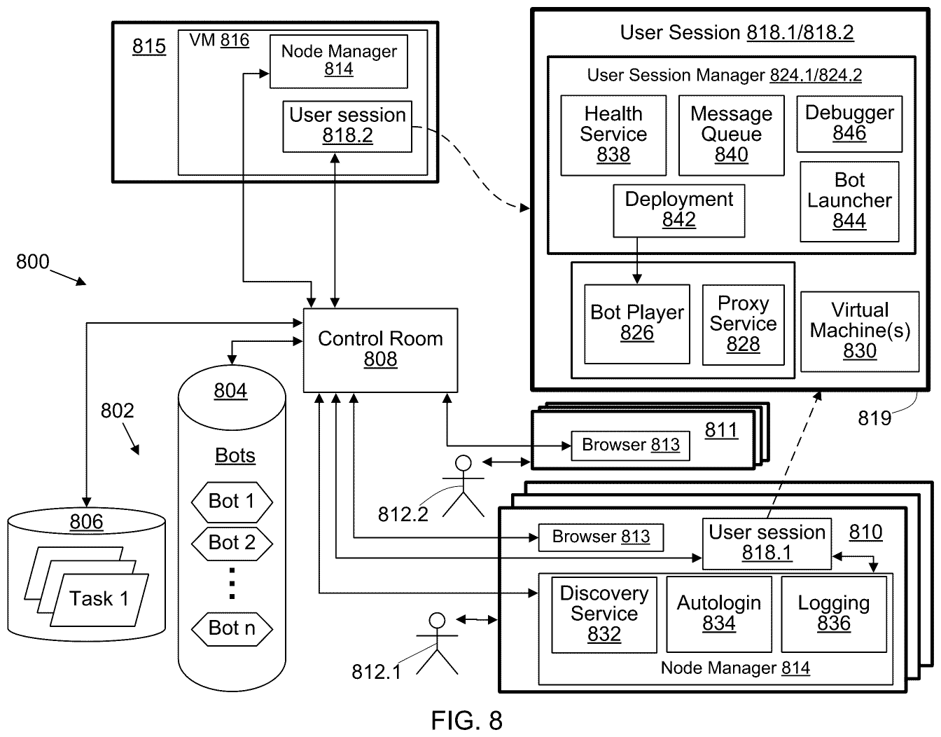

FIG. 8 is a block diagram 800 of an automation system, such as automation system 102 of FIG. 1, or a robotic process automation (RPA) system according to one embodiment. The automation system 800 includes data storage 802. The data storage 802 can store a plurality of automation programs or software robots 804, also referred to as bots (e.g., Bot 1, Bot 2, . . . , Bot n). The software robots 804 can be operable to interact at a user level with one or more user level application programs (not shown). As used herein, the term “bot” is generally synonymous with the term software robot. In certain contexts, as will be apparent to those skilled in the art in view of the present disclosure, the term “bot runner” refers to a device (virtual or physical), having the necessary software capability (such as bot player 826), on which a bot will execute or is executing. The data storage 802 can also stores a plurality of work items 806. Each work item 806 can pertain to processing executed by one or more of the software robots 804.

The RPA system 800 can also include a control room 808. The control room 808 is operatively coupled to the data storage 802 and is configured to execute instructions that, when executed, cause the RPA system 800 to respond to a request from a client device 810 that is issued by a user 812.1. The control room 808 can act as a server to provide to the client device 810 the capability to perform an automation task to process a work item from the plurality of work items 806. The RPA system 800 is able to support multiple client devices 810 concurrently, each of which will have one or more corresponding user session(s) 818, which provides a context. The context can, for example, include security, permissions, audit trails, etc. to define the permissions and roles for bots operating under the user session 818. For example, a bot executing under a user session, cannot access any files or use any applications that the user, under whose credentials the bot is operating, does not have permission to do so. This prevents any inadvertent or malicious acts from a bot under which bot 804 executes.

The control room 808 can provide, to the client device 810, software code to implement a node manager 814. The node manager 814 executes on the client device 810 and provides a user 812 a visual interface via browser 813 to view progress of and to control execution of automation tasks. It should be noted that the node manager 814 can be provided to the client device 810 on demand, when required by the client device 810, to execute a desired automation task. In one embodiment, the node manager 814 may remain on the client device 810 after completion of the requested automation task to avoid the need to download it again. In another embodiment, the node manager 814 may be deleted from the client device 810 after completion of the requested automation task. The node manager 814 can also maintain a connection to the control room 808 to inform the control room 808 that device 810 is available for service by the control room 808, irrespective of whether a live user session 818 exists. When executing a bot 804, the node manager 814 can impersonate the user 812 by employing credentials associated with the user 812.

The control room 808 initiates, on the client device 810, a user session 818 (seen as a specific instantiation 818.1) to perform the automation task. The control room 808 retrieves the set of task processing instructions 804 that correspond to the work item 806. The task processing instructions 804 that correspond to the work item 806 can execute under control of the user session 818.1, on the client device 810. The node manager 814 can provide update data indicative of status of processing of the work item to the control room 808. The control room 808 can terminate the user session 818.1 upon completion of processing of the work item 806. The user session 818.1 is shown in further detail at 819, where an instance 824.1 of user session manager 824 is seen along with a bot player 826, proxy service 828, and one or more virtual machine(s) 830, such as a virtual machine that runs Java® or Python®. The user session manager 824 provides a generic user session context within which a bot 804 executes.

The bots 804 execute on a player, via a computing device, to perform the functions encoded by the bot. Some or all of the bots 804 may in certain embodiments be located remotely from the control room 808. Moreover, the devices 810 and 811, which may be conventional computing devices, such as for example, personal computers, server computers, laptops, tablets and other portable computing devices, may also be located remotely from the control room 808. The devices 810 and 811 may also take the form of virtual computing devices. The bots 804 and the work items 806 are shown in separate containers for purposes of illustration but they may be stored in separate or the same device(s), or across multiple devices. The control room 808 can perform user management functions, source control of the bots 804, along with providing a dashboard that provides analytics and results of the bots 804, performs license management of software required by the bots 804 and manages overall execution and management of scripts, clients, roles, credentials, security, etc. The major functions performed by the control room 808 can include: (i) a dashboard that provides a summary of registered/active users, tasks status, repository details, number of clients connected, number of scripts passed or failed recently, tasks that are scheduled to be executed and those that are in progress; (ii) user/role management—permits creation of different roles, such as bot creator, bot runner, admin, and custom roles, and activation, deactivation and modification of roles; (iii) repository management—to manage all scripts, tasks, workflows and reports etc.; (iv) operations management—permits checking status of tasks in progress and history of all tasks, and permits the administrator to stop/start execution of bots currently executing; (v) audit trail—logs creation of all actions performed in the control room; (vi) task scheduler—permits scheduling tasks which need to be executed on different clients at any particular time; (vii) credential management—permits password management; and (viii) security: management—permits rights management for all user roles. The control room 808 is shown generally for simplicity of explanation. Multiple instances of the control room 808 may be employed where large numbers of bots are deployed to provide for scalability of the RPA system 800.

In the event that a device, such as device 811 (e.g., operated by user 812.2) does not satisfy the minimum processing capability to run a node manager 814, the control room 808 can make use of another device, such as device 815, that has the requisite capability. In such case, a node manager 814 within a Virtual Machine (VM), seen as VM 816, can be resident on the device 815. The node manager 814 operating on the device 815 can communicate with browser 813 on device 811. This approach permits RPA system 800 to operate with devices that may have lower processing capability, such as older laptops, desktops, and portable/mobile devices such as tablets and mobile phones. In certain embodiments the browser 813 may take the form of a mobile application stored on the device 811. The control room 808 can establish a user session 818.2 for the user 812.2 while interacting with the control room 808 and the corresponding user session 818.2 operates as described above for user session 818.1 with user session manager 824 operating on device 810 as discussed above.

In certain embodiments, the user session manager 824 provides five functions. First is a health service 838 that maintains and provides a detailed logging of bot execution including monitoring memory and CPU usage by the bot and other parameters such as number of file handles employed. The bots 804 can employ the health service 838 as a resource to pass logging information to the control room 808. Execution of the bot is separately monitored by the user session manager 824 to track memory, CPU, and other system information. The second function provided by the user session manager 824 is a message queue 840 for exchange of data between bots executed within the same user session 818. The third function is a deployment service (also referred to as a deployment module) 842 that connects to the control room 808 to request execution of a requested bot 804. The deployment service 842 can also ensure that the environment is ready for bot execution, such as by making available dependent libraries. The fourth function is a bot launcher 844 which can read metadata associated with a requested bot 804 and launch an appropriate container and begin execution of the requested bot. The fifth function is a debugger service 846 that can be used to debug bot code.

The bot player 826 can execute, or play back, a sequence of instructions encoded in a bot. The sequence of instructions can, for example, be captured by way of a recorder when a human performs those actions, or alternatively the instructions are explicitly coded into the bot. These instructions enable the bot player 826, to perform the same actions as a human would do in their absence. In one implementation, the instructions can compose of a command (action) followed by set of parameters, for example: Open Browser is a command, and a URL would be the parameter for it to launch a web resource. Proxy service 828 can enable integration of external software or applications with the bot to provide specialized services. For example, an externally hosted artificial intelligence system could enable the bot to understand the meaning of a “sentence.”

The user 812.1 can interact with node manager 814 via a conventional browser 813 which employs the node manager 814 to communicate with the control room 808. When the user 812.1 logs in from the client device 810 to the control room 808 for the first time, the user 812.1 can be prompted to download and install the node manager 814 on the device 810, if one is not already present. The node manager 814 can establish a web socket connection to the user session manager 824, deployed by the control room 808 that lets the user 812.1 subsequently create, edit, and deploy the bots 804.

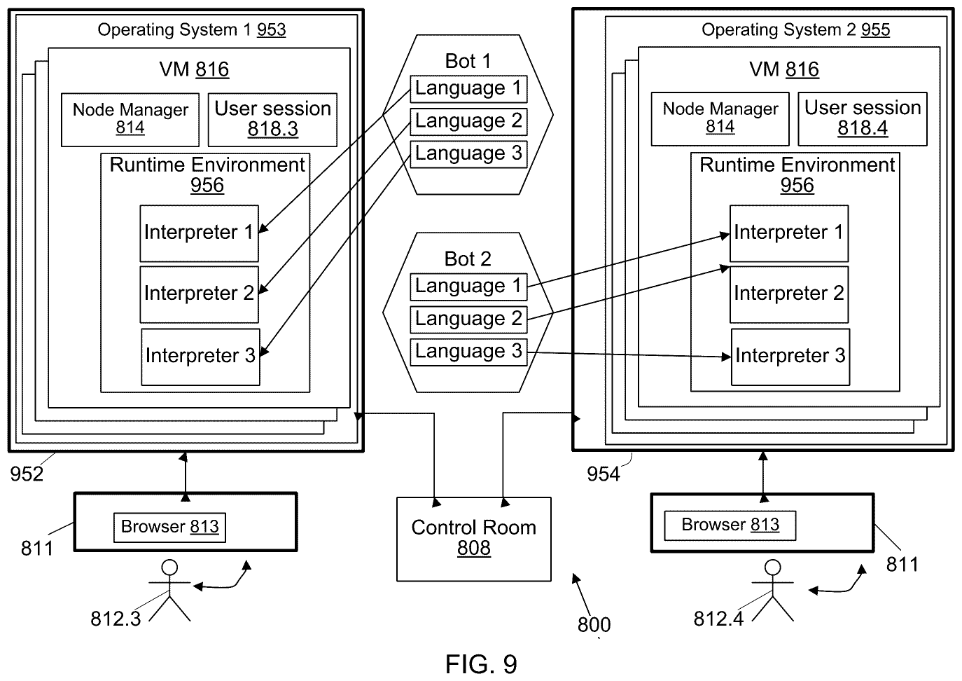

FIG. 9 is a block diagram of a generalized runtime environment for bots 804 in accordance with another embodiment of the RPA system 800 illustrated in FIG. 8. This flexible runtime environment advantageously permits extensibility of the platform to enable use of various languages in encoding bots. In the embodiment of FIG. 9, RPA system 800 generally operates in the manner described in connection with FIG. 8, except that in the embodiment of FIG. 9, some or all of the user sessions 818 execute within a virtual machine 816. This permits the bots 804 to operate on an RPA system 800 that runs on an operating system different from an operating system on which a bot 804 may have been developed. For example, if a bot 804 is developed on the Windows® operating system, the platform agnostic embodiment shown in FIG. 9 permits the bot 804 to be executed on a device 952 or 954 executing an operating system 953 or 955 different than Windows®, such as, for example, Linux. In one embodiment, the VM 816 takes the form of a Java Virtual Machine (JVM) as provided by Oracle Corporation. As will be understood by those skilled in the art in view of the present disclosure, a JVM enables a computer to run Java® programs as well as programs written in other languages that are also compiled to Java® bytecode.

In the embodiment shown in FIG. 9, multiple devices 952 can execute operating system 1, 953, which may, for example, be a Windows® operating system. Multiple devices 954 can execute operating system 2, 955, which may, for example, be a Linux® operating system. For simplicity of explanation, two different operating systems are shown, by way of example and additional operating systems such as the macOS®, or other operating systems may also be employed on devices 952, 954 or other devices. Each device 952, 954 has installed therein one or more VM's 816, each of which can execute its own operating system (not shown), which may be the same or different than the host operating system 953/955. Each VM 816 has installed, either in advance, or on demand from control room 808, a node manager 814. The embodiment illustrated in FIG. 9 differs from the embodiment shown in FIG. 8 in that the devices 952 and 954 have installed thereon one or more VMs 816 as described above, with each VM 816 having an operating system installed that may or may not be compatible with an operating system required by an automation task. Moreover, each VM has installed thereon a runtime environment 956, each of which has installed thereon one or more interpreters (shown as interpreter 1, interpreter 2, interpreter 3). Three interpreters are shown by way of example but any run time environment 956 may, at any given time, have installed thereupon less than or more than three different interpreters. Each interpreter 956 is specifically encoded to interpret instructions encoded in a particular programming language. For example, interpreter 1 may be encoded to interpret software programs encoded in the Java® programming language, seen in FIG. 9 as language 1 in Bot 1 and Bot 2. Interpreter 2 may be encoded to interpret software programs encoded in the Python@ programming language, seen in FIG. 9 as language 2 in Bot 1 and Bot 2, and interpreter 3 may be encoded to interpret software programs encoded in the R programming language, seen in FIG. 9 as language 3 in Bot 1 and Bot 2.

Turning to the bots Bot 1 and Bot 2, each bot may contain instructions encoded in one or more programming languages. In the example shown in FIG. 9, each bot can contain instructions in three different programming languages, for example, Java®, Python@ and R. This is for purposes of explanation and the embodiment of FIG. 9 may be able to create and execute bots encoded in more or less than three programming languages. The VMs 816 and the runtime environments 956 permit execution of bots encoded in multiple languages, thereby permitting greater flexibility in encoding bots. Moreover, the VMs 816 permit greater flexibility in bot execution. For example, a bot that is encoded with commands that are specific to an operating system, for example, open a file, or that requires an application that runs on a particular operating system, for example, Excel® on Windows®, can be deployed with much greater flexibility. In such a situation, the control room 808 will select a device with a VM 816 that has the Windows® operating system and the Excel® application installed thereon. Licensing fees can also be reduced by serially using a particular device with the required licensed operating system and application(s), instead of having multiple devices with such an operating system and applications, which may be unused for large periods of time.

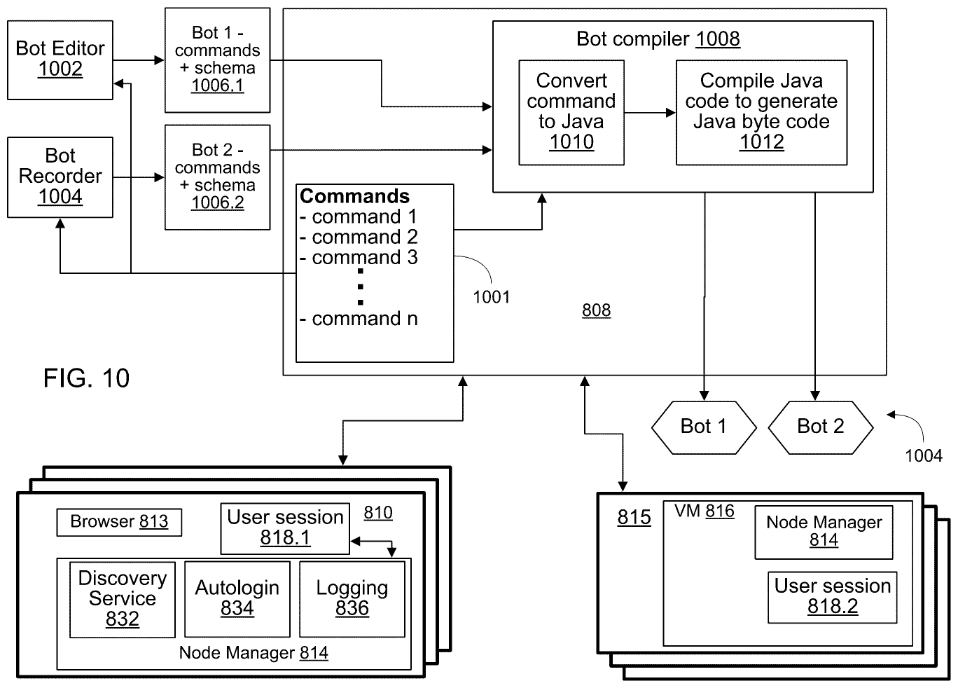

FIG. 10 illustrates a block diagram of yet another embodiment of the RPA system 800 of FIG. 8 configured to provide platform independent sets of task processing instructions for bots 804. Two bots 804, bot 1 and bot 2 are shown in FIG. 10. Each of bots 1 and 2 are formed from one or more commands 1001, each of which specifies a user level operation with a specified application program, or a user level operation provided by an operating system. Sets of commands 1006.1 and 1006.2 may be generated by bot editor 1002 and bot recorder 1004, respectively, to define sequences of application-level operations that are normally performed by a human user. The bot editor 1002 may be configured to combine sequences of commands 1001 via an editor. The bot recorder 1004 may be configured to record application-level operations performed by a user and to convert the operations performed by the user to commands 1001. The sets of commands 1006.1 and 1006.2 generated by the editor 1002 and the recorder 1004 can include command(s) and schema for the command(s), where the schema defines the format of the command(s). The format of a command can, such as, includes the input(s) expected by the command and their format. For example, a command to open a URL might include the URL, a user login, and a password to login to an application resident at the designated URL.

The control room 808 operates to compile, via compiler 1008, the sets of commands generated by the editor 1002 or the recorder 1004 into platform independent executables, each of which is also referred to herein as a bot JAR (Java ARchive) that perform application-level operations captured by the bot editor 1002 and the bot recorder 1004. In the embodiment illustrated in FIG. 10, the set of commands 1006, representing a bot file, can be captured in a JSON (JavaScript Object Notation) format which is a lightweight data-interchange text-based format. JSON is based on a subset of the JavaScript Programming Language Standard ECMA-262 3rd Edition-December 1999. JSON is built on two structures: (i) a collection of name/value pairs; in various languages, this is realized as an object, record, struct, dictionary, hash table, keyed list, or associative array, (ii) an ordered list of values which, in most languages, is realized as an array, vector, list, or sequence. Bots 1 and 2 may be executed on devices 810 and/or 815 to perform the encoded application-level operations that are normally performed by a human user.

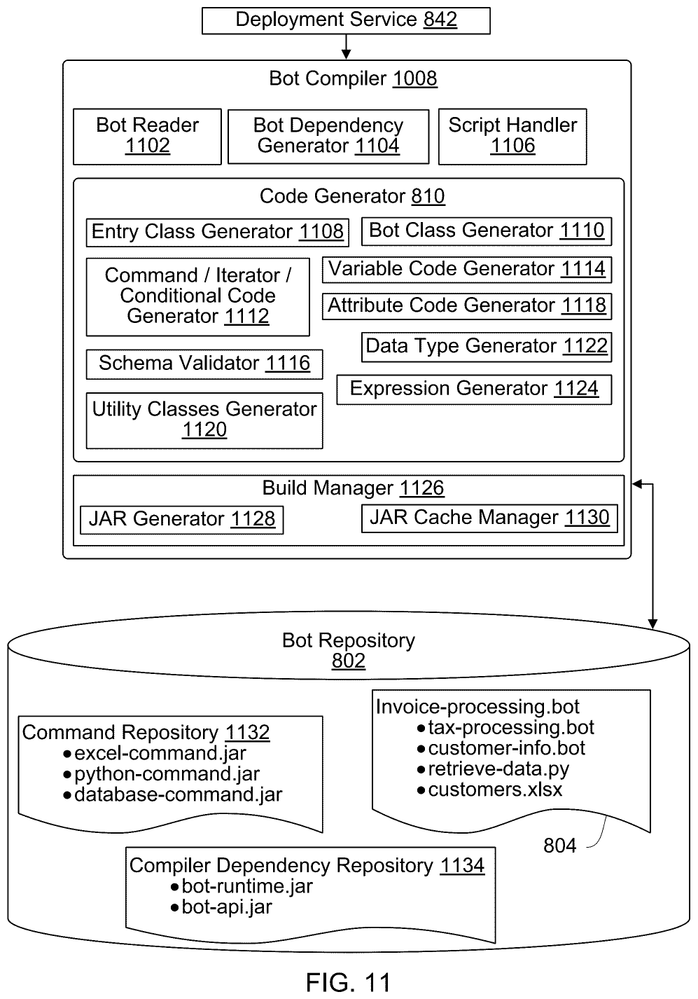

FIG. 11 is a block diagram illustrating details of one embodiment of the bot compiler 1008 illustrated in FIG. 10. The bot compiler 1008 accesses one or more of the bots 804 from the data storage 802, which can serve as bot repository, along with commands 1001 that are contained in a command repository 1132. The bot compiler 808 can also access compiler dependency repository 1134. The bot compiler 808 can operate to convert each command 1001 via code generator module 1010 to an operating system independent format, such as a Java command. The bot compiler 808 then compiles each operating system independent format command into byte code, such as Java byte code, to create a bot JAR. The convert command to Java module 1010 is shown in further detail in in FIG. 11 by JAR generator 1128 of a build manager 1126. The compiling to generate Java byte code module 1012 can be provided by the JAR generator 1128. In one embodiment, a conventional Java compiler, such as javac from Oracle Corporation, may be employed to generate the bot JAR (artifacts). As will be appreciated by those skilled in the art, an artifact in a Java environment includes compiled code along with other dependencies and resources required by the compiled code. Such dependencies can include libraries specified in the code and other artifacts. Resources can include web pages, images, descriptor files, other files, directories and archives.

As noted in connection with FIG. 10, deployment service 842 can be responsible to trigger the process of bot compilation and then once a bot has compiled successfully, to execute the resulting bot JAR on selected devices 810 and/or 815. The bot compiler 1008 can comprises a number of functional modules that, when combined, generate a bot 804 in a JAR format. A bot reader 1102 loads a bot file into memory with class representation. The bot reader 1102 takes as input a bot file and generates an in-memory bot structure. A bot dependency generator 1104 identifies and creates a dependency graph for a given bot. It includes any child bot, resource file like script, and document or image used while creating a bot. The bot dependency generator 1104 takes, as input, the output of the bot reader 1102 and provides, as output, a list of direct and transitive bot dependencies. A script handler 1106 handles script execution by injecting a contract into a user script file. The script handler 1106 registers an external script in manifest and bundles the script as a resource in an output JAR. The script handler 1106 takes, as input, the output of the bot reader 1102 and provides, as output, a list of function pointers to execute different types of identified scripts like Python, Java, VB scripts.

An entry class generator 1108 can create a Java class with an entry method, to permit bot execution to be started from that point. For example, the entry class generator 1108 takes, as an input, a parent bot name, such “Invoice-processing.bot” and generates a Java class having a contract method with a predefined signature. A bot class generator 1110 can generate a bot class and orders command code in sequence of execution. The bot class generator 1110 can take, as input, an in-memory bot structure and generates, as output, a Java class in a predefined structure. A Command/Iterator/Conditional Code Generator 1112 wires up a command class with singleton object creation, manages nested command linking, iterator (loop) generation, and conditional (If/Else If/Else) construct generation. The Command/Iterator/Conditional Code Generator 1112 can take, as input, an in-memory bot structure in JSON format and generates Java code within the bot class. A variable code generator 1114 generates code for user defined variables in the bot, maps bot level data types to Java language compatible types, and assigns initial values provided by user. The variable code generator 1114 takes, as input, an in-memory bot structure and generates Java code within the bot class. A schema validator 1116 can validate user inputs based on command schema and includes syntax and semantic checks on user provided values. The schema validator 1116 can take, as input, an in-memory bot structure and generates validation errors that it detects. The attribute code generator 1118 can generate attribute code, handles the nested nature of attributes, and transforms bot value types to Java language compatible types. The attribute code generator 1118 takes, as input, an in-memory bot structure and generates Java code within the bot class. A utility classes generator 1120 can generate utility classes which are used by an entry class or bot class methods. The utility classes generator 1120 can generate, as output, Java classes. A data type generator 1122 can generate value types useful at runtime. The data type generator 1122 can generate, as output, Java classes. An expression generator 1124 can evaluate user inputs and generates compatible Java code, identifies complex variable mixed user inputs, inject variable values, and transform mathematical expressions. The expression generator 1124 can take, as input, user defined values and generates, as output, Java compatible expressions.

The JAR generator 1128 can compile Java source files, produces byte code and packs everything in a single JAR, including other child bots and file dependencies. The JAR generator 1128 can take, as input, generated Java files, resource files used during the bot creation, bot compiler dependencies, and command packages, and then can generate a JAR artifact as an output. The JAR cache manager 1130 can put a bot JAR in cache repository so that recompilation can be avoided if the bot has not been modified since the last cache entry. The JAR cache manager 1130 can take, as input, a bot JAR.

In one or more embodiment described herein command action logic can be implemented by commands 1001 available at the control room 808. This permits the execution environment on a device 810 and/or 815, such as exists in a user session 818, to be agnostic to changes in the command action logic implemented by a bot 804. In other words, the manner in which a command implemented by a bot 804 operates need not be visible to the execution environment in which a bot 804 operates. The execution environment is able to be independent of the command action logic of any commands implemented by bots 804. The result is that changes in any commands 1001 supported by the RPA system 800, or addition of new commands 1001 to the RPA system 800, do not require an update of the execution environment on devices 810, 815. This avoids what can be a time and resource intensive process in which addition of a new command 1001 or change to any command 1001 requires an update to the execution environment to each device 810, 815 employed in an RPA system. Take, for example, a bot that employs a command 1001 that logs into an on-online service. The command 1001 upon execution takes a Uniform Resource Locator (URL), opens (or selects) a browser, retrieves credentials corresponding to a user on behalf of whom the bot is logging in as, and enters the user credentials (e.g., username and password) as specified. If the command 1001 is changed, for example, to perform two-factor authentication, then it will require an additional resource (the second factor for authentication) and will perform additional actions beyond those performed by the original command (for example, logging into an email account to retrieve the second factor and entering the second factor). The command action logic will have changed as the bot is required to perform the additional changes. Any bot(s) that employ the changed command will need to be recompiled to generate a new bot JAR for each changed bot and the new bot JAR will need to be provided to a bot runner upon request by the bot runner. The execution environment on the device that is requesting the updated bot will not need to be updated as the command action logic of the changed command is reflected in the new bot JAR containing the byte code to be executed by the execution environment.

The embodiments herein can be implemented in the general context of computer-executable instructions, such as those included in program modules, being executed in a computing system on a target, real or virtual, processor. Generally, program modules include routines, programs, libraries, objects, classes, components, data structures, etc. that perform particular tasks or implement particular abstract data types. The program modules may be obtained from another computer system, such as via the Internet, by downloading the program modules from the other computer system for execution on one or more different computer systems. The functionality of the program modules may be combined or split between program modules as desired in various embodiments. Computer-executable instructions for program modules may be executed within a local or distributed computing system. The computer-executable instructions, which may include data, instructions, and configuration parameters, may be provided via an article of manufacture including a computer readable medium, which provides content that represents instructions that can be executed. A computer readable medium may also include a storage or database from which content can be downloaded. A computer readable medium may further include a device or product having content stored thereon at a time of sale or delivery. Thus, delivering a device with stored content, or offering content for download over a communication medium, may be understood as providing an article of manufacture with such content described herein.

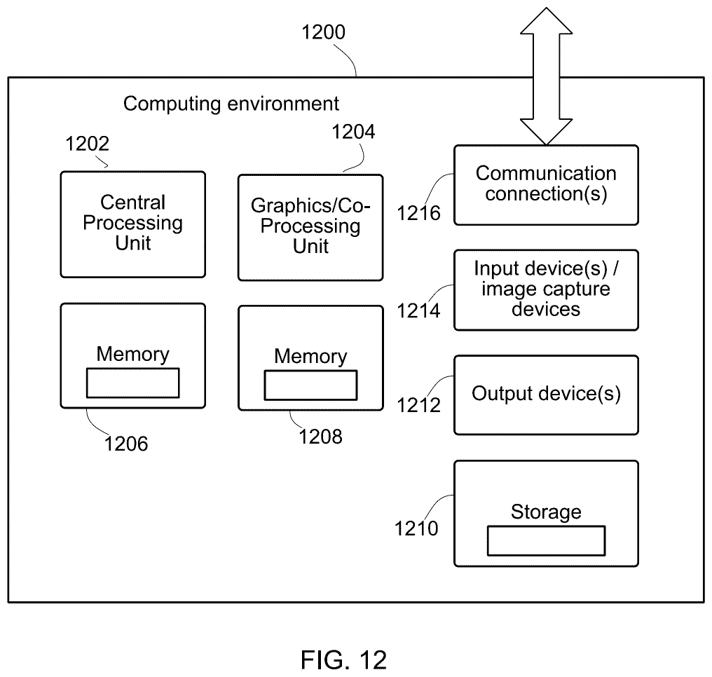

FIG. 12 illustrates a block diagram of an exemplary computing environment 1200 for an implementation of an RPA system, such as the RPA systems disclosed herein. The embodiments described herein may be implemented using the exemplary computing environment 1200. The exemplary computing environment 1200 includes one or more processing units 1202, 1204 and memory 1206, 1208. The processing units 1202, 1206 execute computer-executable instructions. Each of the processing units 1202, 1206 can be a general-purpose central processing unit (CPU), processor in an application-specific integrated circuit (ASIC) or any other type of processor. For example, as shown in FIG. 12, the processing unit 1202 can be a CPU, and the processing unit can be a graphics/co-processing unit (GPU). The tangible memory 1206, 1208 may be volatile memory (e.g., registers, cache, RAM), non-volatile memory (e.g., ROM, EEPROM, flash memory, etc.), or some combination of the two, accessible by the processing unit(s). The hardware components may be standard hardware components, or alternatively, some embodiments may employ specialized hardware components to further increase the operating efficiency and speed with which the RPA system operates. The various components of exemplary computing environment 1200 may be rearranged in various embodiments, and some embodiments may not require nor include all of the above components, while other embodiments may include additional components, such as specialized processors and additional memory.

The exemplary computing environment 1200 may have additional features such as, for example, tangible storage 1210, one or more input devices 1214, one or more output devices 1212, and one or more communication connections 1216. An interconnection mechanism (not shown) such as a bus, controller, or network can interconnect the various components of the exemplary computing environment 1200. Typically, operating system software (not shown) provides an operating system for other software executing in the exemplary computing environment 1200, and coordinates activities of the various components of the exemplary computing environment 1200.

The tangible storage 1210 may be removable or non-removable, and includes magnetic disks, magnetic tapes or cassettes, CD-ROMs, DVDs, or any other medium which can be used to store information in a non-transitory way, and which can be accessed within the computing system 1200. The tangible storage 1210 can store instructions for the software implementing one or more features of a PRA system as described herein.

The input device(s) or image capture device(s) 1214 may include, for example, one or more of a touch input device (such as a keyboard, mouse, pen, or trackball), a voice input device, a scanning device, an imaging sensor, touch surface, or any other device capable of providing input to the exemplary computing environment 1200. For multimedia embodiment, the input device(s) 1214 can, for example, include a camera, a video card, a TV tuner card, or similar device that accepts video input in analog or digital form, a microphone, an audio card, or a CD-ROM or CD-RW that reads audio/video samples into the exemplary computing environment 1200. The output device(s) 1212 can, for example, include a display, a printer, a speaker, a CD-writer, or any another device that provides output from the exemplary computing environment 1200.

The one or more communication connections 1216 can enable communication over a communication medium to another computing entity. The communication medium conveys information such as computer-executable instructions, audio or video input or output, or other data. The communication medium can include a wireless medium, a wired medium, or a combination thereof.

The various aspects, features, embodiments or implementations of the invention described above can be used alone or in various combinations.

Embodiments of the invention can, for example, be implemented by software, hardware, or a combination of hardware and software. Embodiments of the invention can also be embodied as computer readable code on a computer readable medium. In one embodiment, the computer readable medium is non-transitory. The computer readable medium is any data storage device that can store data which can thereafter be read by a computer system. Examples of the computer readable medium generally include read-only memory and random-access memory. More specific examples of computer readable medium are tangible and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

The embodiments herein can be implemented in the general context of computer-executable instructions, such as those included in program modules, being executed in a computing system on a target, real or virtual, processor. Generally, program modules include routines, programs, libraries, objects, classes, components, data structures, etc. that perform particular tasks or implement particular abstract data types. The program modules may be obtained from another computer system, such as via the Internet, by downloading the program modules from the other computer system for execution on one or more different computer systems. The functionality of the program modules may be combined or split between program modules as desired in various embodiments. Computer-executable instructions for program modules may be executed within a local or distributed computing system. The computer-executable instructions, which may include data, instructions, and configuration parameters, may be provided via an article of manufacture including a computer readable medium, which provides content that represents instructions that can be executed. A computer readable medium may also include a storage or database from which content can be downloaded. A computer readable medium may further include a device or product having content stored thereon at a time of sale or delivery. Thus, delivering a device with stored content, or offering content for download over a communication medium, may be understood as providing an article of manufacture with such content described herein.

Numerous specific details are set forth in order to provide a thorough understanding of the present invention. However, it will become obvious to those skilled in the art that the invention may be practiced without these specific details. The description and representation herein are the common meanings used by those experienced or skilled in the art to most effectively convey the substance of their work to others skilled in the art. In other instances, well-known methods, procedures, components, and circuitry have not been described in detail to avoid unnecessarily obscuring aspects of the present invention.

In the foregoing description, reference to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

1. A computer-implemented method for generating a dataset for training a machine learning model suitable for suggesting actions for automating processes, the computer-implemented method comprising:
accessing a repository of an automation system which contains a plurality of files;
identifying, by an automation file identification module, one of the plurality of files to be an automation file;
filtering for automation process metadata within the files;
removing automation process metadata corresponding to one or more automation steps that appear more than one time in an automation file; and
generating a string format version of the identified automation file, wherein the string format version includes the identified automation process metadata.

2. A computer-implemented method as recited in claim 1, wherein the filtering for automation process metadata comprises:
filtering for command package names and command names.

3. A computer-implemented method as recited in claim 2, wherein the automation process metadata comprises dependency parameters.

4. A computer-implemented method as recited in claim 2, wherein the filtering for automation process metadata comprises:
filtering for attributes of commands.

5. A computer-implemented method as recited in claim 4,
wherein the automation process metadata comprises: name, type, iterator type, and condition name, and
wherein the condition name comprises at least one of: loop type, iterator, and iterator TableRow.

6. A computer-implemented method as recited in claim 2, wherein the filtering for automation process metadata comprises:
accessing a repository of an automation system that stores a plurality of files; and
configuring an automation process metadata filter to identify automation process metadata within the plurality of files based on a master list of automation process packages and command names.

7. A computer-implemented method as recited in claim 2, wherein the filtering for automation process metadata comprises:
configuring an automation process metadata filter to identify automation process metadata based on a master list of attributes for each command.

8. A computer-implemented method as recited in claim 1, wherein the files are JSON files, XML files, or automation process instruction files.

9. A computer-implemented method as recited in claim 1, wherein the computer-implemented method comprises:
converting identified automation files into object node representation format.

10. A computer-implemented method as recited in claim 1, wherein the computer-implemented method comprises:
identifying attributes by an attribute identification module, wherein the attributes are parameters that specify how the command actions are to be executed.

11. A computer-implemented method as recited in claim 10, wherein the computer-implemented method comprises:
subsequent to the identifying of the attributes, adding the identified attributes into an object node representation of the identified automation file.

12. A computer-implemented method as recited in claim 1, wherein the computer-implemented method comprises:
filtering sequences for those supported by a particular instance of an automation system; and
filtering out the packages that are not supported by the particular instance of the automation system.

13. A computer-implemented method as recited in claim 1, wherein the computer-implemented method comprises:
filtering out metadata related to non-standard commands/packages.

14. A computer-implemented method as recited in claim 1, wherein the computer-implemented method comprises:
removing automation process metadata that is duplicative.

15. A computer-implemented method as recited in claim 1, wherein the generating a string format version of the identified automation file comprises:
inserting the package name, command names, and attributes into the string format version of the automation file.

16. A computer readable medium including at least computer program code tangibly stored thereon for generating a dataset for training a machine learning model suitable for suggesting actions for creating automation files for user in an automation system that automates processes, the computer readable medium comprising:
computer program code for accessing a repository of an automation system which contains a plurality of files;
computer program code for identifying, by an automation file identification module, one of the plurality of files to be an automation file;
computer program code for filtering for automation process metadata within the files;
computer program code for removing automation process metadata corresponding to one or more automation steps that appear more than one time in an automation file; and
computer program code for generating a string format version of the identified automation file, wherein the string format version includes the identified automation process metadata.

17. A computer readable medium as recited in claim 16, wherein the computer readable medium comprises:
computer program code for identifying attributes by an attribute identification module, wherein the attributes are parameters that specify how the command actions are to be executed.

18. A computer readable medium as recited in claim 16, wherein the computer readable medium comprises:
computer program code for subsequent to the identifying of the attributes, adding the identified attributes into an object node representation of the identified automation file.

19. A computer readable medium as recited in claim 16, wherein the computer readable medium comprises:
computer program code for filtering sequences for those supported by a particular instance of an automation system; and
computer program code for filtering out the packages that are not supported by the particular instance of the automation system.

20. A computer readable medium as recited in claim 16, wherein the computer program code for filtering for automation process metadata comprises:
filtering for command package names and command names; and
filtering for attributes of commands.

21. A robotic process automation system, comprising:
a repository configured to store a plurality of files;
a dataset processing module configured to:
identifying, by an automation file identification module, one of the plurality of files to be an automation file;
filtering for automation process metadata within the files; and
generating a string format version of the identified automation file, wherein the string format version includes the identified automation process metadata; and
a machine learning model training system configured to produce an automation machine learning model based on at least the string format version of the identified automation file.

22. A robotic process automation system as recited in claim 21, wherein the machine learning model training system uses a dataset that has been trained to produce the machine learning model, wherein the machine learning training model is trained to suggesting actions for use in an automation process being created.

23. A robotic process automation system as recited in claim 22, wherein the machine learning model is a generative Artificial Intelligence (AI) model.
